(19) United States
(12) Patent Application Publication
(10) Pub. No.: US 2020/0349714 A1
(43) Pub. Date: Nov. 5, 2020

(54) PROJECTION APPARATUS AND OPERATION METHOD THEREOF

(71) Applicant: Coretronic Corporation, Hsin-Chu (TW)

(72) Inventors: Chuang-Yuan Cheng, Hsin-Chu (TW); An-Ching Tung, Hsin-Chu (TW); Chung-Kuang Lin, Hsin-Chu (TW); Jih-Shun Lo, Hsin-Chu (TW)

(73) Assignee: Coretronic Corporation, Hsin-Chu (TW)

(21) Appl. No.: 16/861,212

(22) Filed: Apr. 29, 2020

(30) Foreign Application Priority Data
Apr. 30, 2019 (CN) 201910359671.X

(51) Int. Cl. G06T 7/13; G06T 7/70; H04N 9/31

(52) U.S. Cl. CPC G06T 7/13; G06T 7/70; G06T 2207/30201; H04N 9/3179; G06T 2207/10048; H04N 9/3155

(57) ABSTRACT

The present invention provides a projection apparatus and an operation method thereof. The projection apparatus comprises a projector and an image capturing device electrically connected to the projector. The projector provides a projection space, and the image capturing device provides an image capturing space. The projection space is located in the image capturing space. The image capturing device is configured to identify a boundary of the projection space in the image capturing space and is configured to detect a biological part located in the projection space. The image capturing device is configured to calculate a position of the biological part in the projection space, and the projector projects a mask block corresponding to the position of the biological part in the projection space. The present invention may prevent the light beam from interfering with a user.

### CROSS-REFERENCE TO RELATED APPLICATION

This application claims the priority benefit of China application serial no. 201910359671.X, filed on Apr. 30, 2019. The entirety of the above-mentioned patent application is hereby incorporated by reference herein and made a part of this specification.

### BACKGROUND OF THE INVENTION

### 1. Field of the Invention

The present invention relates to a projection apparatus and an operation method thereof, and more particularly to a projection apparatus that may preferably project a mask block and an operation method thereof.

### 2. Description of Related Art

With the development of projection technology, projectors have been widely used in homes, offices, schools and other places. In general, when a user, such as reporter or the like, approaches a projection screen or enters the transmission path of the light beam projected from a projector, the user may be interrupted by the light beam from the projector. The light beam may affect the user's speech and may also harm the user's eyes.

Therefore, it is an important issue for those skilled in the art to design a mechanism that may prevent the user from being affected by the light beam projected from the projector.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention were acknowledged by a person of ordinary skill in the art.

### SUMMARY OF THE INVENTION

The present invention provides a projection apparatus and an operation method thereof, which may prevent the light beam from interfering with a user.

An embodiment of the present invention provides a projection apparatus, and the projection apparatus comprises a projector and an image capturing device. The projector provides a projection space. The image capturing device is electrically connected to the projector and provides an image capturing space, and the projection space is located in the image capturing space. The image capturing device is configured to identify a boundary of the projection space in the image capturing space. The image capturing device is configured to detect a biological part located in the projection space. The image capturing device is configured to calculate a position of the biological part in the projection space. The projector projects a mask block corresponding to the position of the biological part in the projection space.

Another embodiment of the present invention provides an operation method for a projection apparatus, and the projection apparatus comprises a projector and an image capturing device electrically connected to the projector. The operation method comprises the projector providing a projection space. The image capturing device provides an image capturing space, and the projection space is located in the image capturing space. The image capturing device is configured to identify a boundary of the projection space in the image capturing space. The image capturing device is configured to detect a biological part located in the projection space. The image capturing device is configured to calculate a position of the biological part in the projection space. The projector projects a mask block corresponding to the position of the biological part in the projection space.

Based on the above, according to the projection apparatus and the operation method thereof provided in the present invention, when a biological part, such as a human or part of a human (such as, face), appears in the projection space, the projector may project a mask block at a corresponding position. Thereby, the living body (for example, the human body) located in the projection space may be protected and be prevented from glare or other discomforts caused from the direct light beam from the projector to the face.

In order to make the aforementioned features and advantages of the present invention clearer and easier to understand, embodiments accompanied with figures are described in detail below.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of projection by a projection apparatus according to an embodiment of the present invention.

FIG. 2 shows an operation method for a projection apparatus according to an embodiment of the present invention.

### DESCRIPTION OF THE EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention may be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

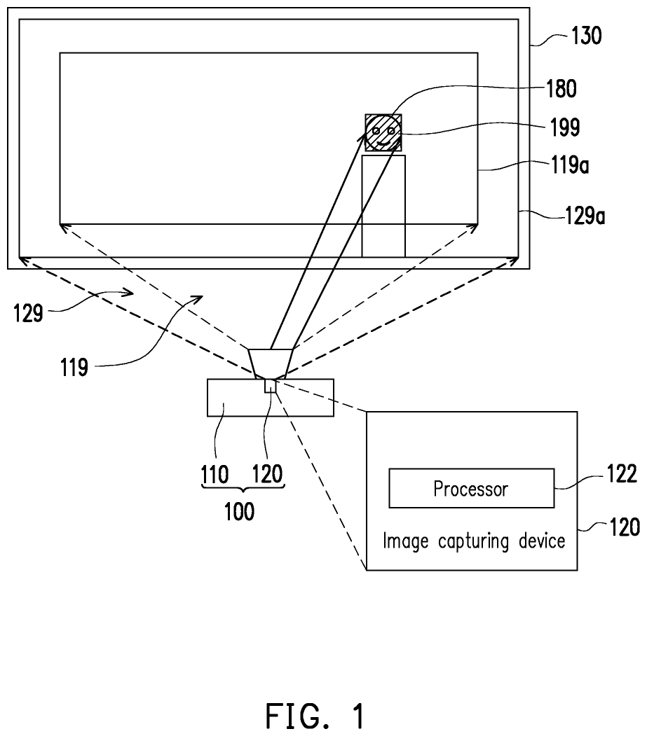

Please refer to FIG. 1, and FIG. 1 is a schematic diagram of projection by a projection apparatus 100 according to an embodiment of the present invention. In this embodiment, the projection apparatus 100 comprises a projector 110 and an image capturing device 120. The projector 110 provides a projection space 119, and the projection space 119 is, for example, a stereoscopic space that may be covered by a light beam projected from the projector 110. In detail, the projection space 119 may be a three-dimensional space defined at least by the projector 110, the edge light beam projected from the projector 110 and a projection target 130 (for example, a wall or a screen). The projection space 119 may correspondingly define a projection area 119a on the projection target 130 (for example, the wall or the screen), that is, an area where the light beam of the projector 110 is irradiated on the projection target 130. In FIG. 1, the projection area 119a may be a two-dimensional area.

In an embodiment, the projector 110 may comprise, for example, an illumination module, an optical engine module, and a lens module. In this embodiment, the illumination module may provide an illumination beam. The optical engine module is located on the transmission path of the illumination beam and is used to convert the illumination beam into an image beam. The lens module is used to project the image beam onto a projection target such as a wall or a screen to form an image. In other embodiments, the projector 110 may also comprise other elements, such as a heat dissipation module, but the present disclosure is not limited thereto.

In an embodiment, the image capturing device 120 may be electrically connected to the projector 110 and may provide an image capturing space 129. The image capturing space 129 is, for example, a stereoscopic space where the image capturing device 120 may take capturing. In detail, the image capturing space 129 may be a three-dimensional space defined at least by the image capturing device 120 and the projection target 130 (for example, the wall or the screen). The image capturing space 129 may correspondingly define an image capturing area 129a on the projection target 130. In FIG. 1, the image capturing area 129a may be a two-dimensional area. In various embodiments, the image capturing device 120 may be implemented as any image capturing facility or stereo camera including a charge coupled device (CCD) lens, a complementary metal oxide semiconductor transistor (CMOS) lens or an infrared lens, as long as the image capturing facility may be used to capture images, which may not depart from the scope of the embodiments of the present invention.

In an embodiment, the projection apparatus 100 may further comprise a processor 122. The processor 122 is electrically connected to the projector 110 and the image capturing device 120. The processor 122 may be disposed in the projection apparatus 100. For example, the processor 122 may be disposed in the projector 110 or the image capturing device 120 of the projection apparatus 100. The processor 122 may also be externally connected to the projection apparatus 100 by a wireless or wired connection. For example, the processor 122 may be externally connected to the projector 110 or the image capturing device 120 of the projection apparatus 100 by a wireless or wired connection. In the embodiment shown in FIG. 1, the processor 122 is disposed in the image capturing device 120, but the present disclosure is not limited thereto. The processor 122 may be a general purpose processor, an application specific processor, a conventional processor, a digital signal processor, a plurality of microprocessors, one or more microprocessors combined with a digital signal processor core, a controller, a microcontroller, an application specific integrated circuit (ASIC), a field programmable gate array (FPGA), any other kind of integrated circuit, a state machine, an advanced RISC machine (ARM) based processor, and the like.

As shown in FIG. 1, the projection space 119 may be located in the image capturing space 129. In other words, the range of the light beam projected from the projector 110 may be within the spatial space where the image capturing device 120 may take capturing. In this case, the projection area 119 may be correspondingly located in the image capturing area 129.

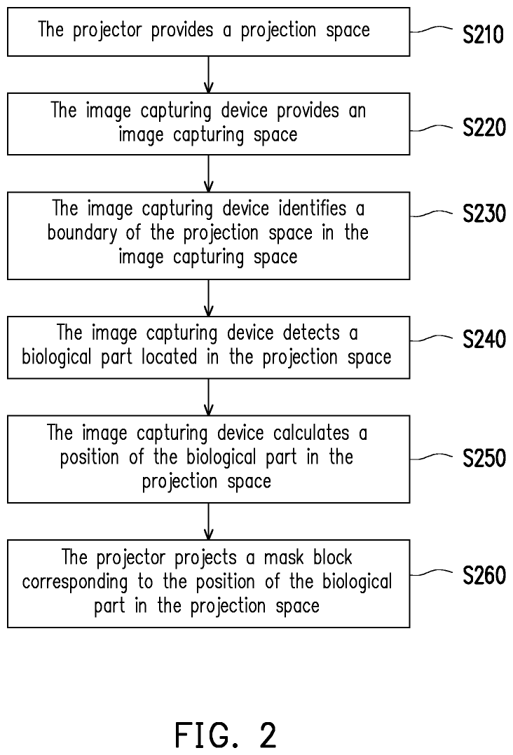

Please refer to FIG. 2, and FIG. 2 shows an operation method for a projection apparatus according to an embodiment of the present invention. The method shown in FIG. 2 may be performed by the projection apparatus 100 shown in FIG. 1, and the details of the steps of FIG. 2 will be described below in conjunction with the various elements of FIG. 1. However, the invention is not limited thereto.

In step S210, the projector 110 may provide a projection space 119. In step S220, the image capturing device 120 may provide an image capturing space 129. For details of steps S210 and S220, references may be made to the description of the embodiment shown in FIG. 1, and details of the references may not be described.

In step S230, the boundary of the projection space 119 in the image capturing space 129 is identified by the image capturing device 120. In an embodiment, the projection area 119a defined at least by the projection space 119 on the projection target 130 corresponds to a boundary of the projection space 119, and the image capturing area 129a defined by the image capturing space 129 on the projection target 130 corresponds to a boundary of the image capturing space 129. In this embodiment, the edge detecting operation is performed by the image capturing device 120 to identify the boundary of the projection area 119a in the image capturing area 129a. Specifically, since the projection area 119a is located in the image capturing area 129a, when the projector 110 projects the light beam onto the projection target 130, the brightness of the projection area 119a (for example, a rectangular area) is made higher than the brightness of the surrounding area, resulting in a significant contrast, that is, the gray scale difference. With the image capturing device 120 capturing an image, the processor 122 of the image capturing device 120 is configured to calculate the position of the edge of the projection area 119a on the projection target 130 based on the gray scale difference presented by the image. In this embodiment, based on the gray scale differences, the image capturing device 120 may be configured to calculate boundaries of the projection area 119a, for example, the rectangular area, in the horizontal direction and/or the vertical direction respectively, thereby positioning the projection area 119a in the image capturing area 129a, but the present invention may not be limited thereto.

In an embodiment, the lower left corner of the image capturing area 129a may be defined as the exemplary origin coordinate (0, 0), and therefore the coordinate of the lower left corner of the projection area 119a may be characterized as the coordinate (X, Y). The length and width of the projection area 119a may be characterized as L and W respectively. Based on the above parameters, such as X, Y, L and W, the image capturing device 120 may position the projection area 119a and determine the size of the projection area 119a. Since the projection area 119a is the area irradiated by the light beam of the projector 110 on the projection target 130, the position and size of the projection space 119 in the image capturing space 129 may be calculated according to the position and size of the projection area 119a. However, the present invention may not be limited thereto.

In step S240, a biological part 199 in the projection space 119 is detected by the image capturing device 120. In an embodiment, the image capturing device 120 may comprise, for example, an infrared sensor or a thermal imager that may be configured to capture images within the range of the image capturing space 129. For example, the thermal imager of the image capturing device 120 may convert the heat information generated by the light beam into an electrical signal, thereby sensitizing and imaging the infrared light emitted or reflected from the object. For example, the higher the temperature of the object is, the higher the brightness of corresponding object image is. The processor 122 may be configured to calculate the temperature distribution in the projection space 119 based on the brightness distribution of the image, and determine whether the biological part 199 exists in the projection space 119. In FIG. 1, the biological part 199 may be a part of a living body, for example, a human face or the like, but the present invention may not be limited thereto.

In an embodiment, in the calculated temperature distribution corresponding to the projection space 119, when a temperature value is higher than a temperature threshold, the processor 122 may determine that the biological part 199 exists in the projection space 119. For example, the above temperature threshold may be a temperature value that is slightly lower than or equal to the temperature of the human body. In such case, in the temperature distribution of the projection space 119, a temperature value higher than the temperature threshold may indicate that a biological part 199 such as a human face exists in the projection space 119. In another embodiment, the temperature threshold may also be a human face temperature reference value calculated based on a large amount of human face temperature data, such as an average value, but the present invention is not limited thereto.

In step S250, the processor 122 may be configured to calculate the position of the biological part 199 in the projection space 119. In this embodiment, the position of the biological part 199 may be characterized, for example, as three-dimensional coordinate (x, y, z) in the projection space 119.

Thereafter, in step S260, the projector 110 projects a mask block 180 corresponding to the position of the biological part 199 in the projection space 119, and the mask block 180 may be overlapped with the image projected by the light beam. Thereby, at the position of the biological part 199, the passing light beam may be lower in brightness.

In an embodiment, the covered area of the mask block 180 on the projection target 130 is not smaller than the projected area of the biological part 199 on the projection target. Moreover, the mask block 180 may be a black block. In other words, after the projector 110 projects the mask block 180, the light beam projected onto the biological part 199 (for example, a human face) may be reduced/eliminated. Therefore, in the situation shown in FIG. 1, the human body located in the projection space 119 does not feel glare or other discomfort caused from the light beam irradiated from the projector 110 toward the face.

In other embodiments, the mask block 180 may be selected from a mask block group, and the mask block group comprises a plurality of mask blocks of different sizes, shapes, and/or brightness levels. That is, depending on the projected area of the biological part 199 on the projection target 130, the projector 110 may adaptively select a mask block of a sufficient size from the mask block group to cover the projected area.

In another embodiment, the mask block 180 is formed by ways of splicing a plurality of sub-mask blocks. For example, the aforementioned sub-mask block is, for example, a mask block with a smaller size. In this case, depending on the projected area of the biological part 199 on the projection target 130, the projector 110 may adaptively splice a plurality of sub-mask blocks so that a mask block of sufficient shape/size may be formed to cover the projected area.

In an embodiment, the user may generate an on screen display (OSD) through a remote controller (not shown) or a physical button (not shown) on the projector 110. The on screen display may present a mask block 180, and the projector 110 may activate the on screen display (OSD) at a corresponding position after detecting the position of the biological part 199, thereby achieving the effect of projecting the mask block 180 to protect the biological part 199.

Moreover, in other embodiments, since the biological part 199 may move with the movement of the human body, the method shown in FIG. 2 may be performed repeatedly to thereby correspondingly change the position/size/shape of the mask block 180 projected from the projector 110 in response to the movement of the biological part 199. For example, the mask block 180 may be iteratively updated every few hundred milliseconds.

Moreover, in some embodiments, when a plurality of biological parts are in the projection space 119, the projector 110 of the present invention may correspondingly project a plurality of mask blocks to positions of these biological parts. Thereby, it is possible to avoid the situation in which the living body feels uncomfortable due to the light beam from the projector 110.

In other embodiments, when the processor 122 determines that the biological part 199 exists in the projection space 119, the projector 110 may also be controlled by the processor 122 to reduce the luminous flux of the projector 110. In this embodiment, the luminous flux of the projector 110 may be related to, for example, the overall brightness of the projected beam. In this arrangement, the overall brightness of the light beam projected from the projector 110 may be reduced while the mask block 180 is projected. Thereby, it is possible to further prevent the living body or other viewers from feeling visually uncomfortable due to large contrast between the mask block 180 and the surrounding image on the screen or the wall.

In an embodiment, the processor 122 may be configured to calculate the distance of the biological part 199 in the projection space 119 from the projector 110. The luminous flux of the projector 110 may be reduced by an adjustment extent, and the adjustment extent may be negatively correlated with the distance of the biological part 199 from the projector 110. That is, the larger the distance of the biological part 199 from the projector 110 is, the smaller the adjustment extent of the reduced luminous flux is. The smaller the distance of the biological part 199 from the projector 110 is, the larger the adjustment extent of the reduced luminous flux is.

In an embodiment, the processor 122 may comprise a memory for storing data. In this embodiment, when the biological part 199 is movable back and forth, and/or left and right in the projection space 119 of the projector 110, the processor 122 may be configured to calculate the distance, position, and/or size of the biological part 199 away from the projector 110. In an embodiment, the memory may be used to store the following information: the corresponding relation between the distance, the position, and/or the size and the above adjustment extent. In this embodiment, after the processor 122 calculating the distance, position, and/or size of the biological part 199, the corresponding adjustment extent may be found according to the corresponding relation stored in the memory, thereby adjusting the luminous flux of the projector 110. In an embodiment, the corresponding relation between the distance, position, and/or size of the biological part 199 and the adjustment extent may be presented in a fuzzy table. In this embodiment, for example, the input parameter of the fuzzy table may be the size or position of the biological part, and the adjustment extent may be obtained by searching the fuzzy table. In this embodiment, based on the adjustment extent obtained by looking up the table, the projector 110 may be controlled by the processor 122 to adjust the luminous flux of the projector 110.

Based on the above, according to the projection apparatus and the operation method thereof provided in the invention, when a biological part, such as a human or part of a human (such as, face), appears in the projection space, the projector may project a mask block at the corresponding position. Thereby, the living body (for example, the human body) located in the projection space may be protected and be prevented from glare or other discomforts caused from the direct light beam from the projector to the face.

Moreover, the projector of the present invention may also change the projection position of the mask block with the movement of the living body (for example, the human body) in the projection space. The projector of the present invention may project a plurality of mask blocks at a time corresponding to a plurality of biological parts (such as human faces) in the projection space. That is, the present invention may dynamically and flexibly prevent one or more biological parts located in the projection space from feeling uncomfortable due to the light beam of the projector. Although the present invention has been disclosed with the above embodiments, it is not intended to limit the present invention. Any person skilled in the art can make some changes and modifications without departing from the spirit and scope of the present invention. Therefore, the protection scope of the present invention shall be defined by the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. In addition, any of the embodiments or the claims of the present disclosure is not required to achieve all of the objects or advantages or features disclosed in the present disclosure. In addition, the abstract and the name of the present invention are only used to assist in the retrieval of patent documents, and are not intended to limit the scope of the present disclosure. In addition, the terms “first”, “second” and the like mentioned in the specification or the claims are used only to designate the names of the elements or to distinguish different embodiments or ranges, and are not intended to limit the upper or lower limit of the number of elements.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection apparatus, comprising:
a projector providing a projection space;
an image capturing device electrically connected to the projector and providing an image capturing space, wherein the projection space is located in the image capturing space, wherein:
the image capturing device is configured to identify a boundary of the projection space in the image capturing space;
the image capturing device is configured to detect a biological part located in the projection space;
the image capturing device is configured to calculate a position of the biological part in the projection space; and
the projector is configured to project a mask block corresponding to the position of the biological part in the projection space.

2. The projection apparatus according to claim 1, wherein the image capturing device comprises an infrared sensor or a thermal imager.

3. The projection apparatus according to claim 1, wherein the boundary between the projection space and the image capturing space is defined by a projection target, the projection space defines a projection area on the projection target, and the image capturing space defines an image capturing area on the projection target.

4. The projection apparatus according to claim 1, wherein the step of identifying the boundary of the projection space in the image capturing space comprises: performing an edge detecting operation to identify the boundary of the projection area in the image capturing area.

5. The projection apparatus according to claim 3, wherein a projected area of the mask block on the projection target is not smaller than a projected area of the biological part on the projection target.

6. The projection apparatus according to claim 1, wherein the projection apparatus further comprises a processor, and the processor is electrically connected to the projector and the image capturing device.

7. The projection apparatus according to claim 6, wherein the processor is disposed in the projector or the image capturing device.

8. The projection apparatus according to claim 6, wherein the step of detecting the biological part located in the projection space comprises: the image capturing device capturing an image for the projection space; the processor calculating a temperature distribution in the projection space based on a brightness distribution of the image; and the processor determining whether the biological part exists in the projection space.

9. The projection apparatus according to claim 8, wherein the step of determining whether the biological part exists in the projection space comprises: in the calculated temperature distribution in the projection space, when a temperature value is higher than a temperature threshold, determining that the biological part exists in the projection space.

10. The projection apparatus according to claim 1, wherein the biological part is a face of a living body.

11. The projection apparatus according to claim 1, wherein the mask block is selected from a mask block group, wherein the mask block group comprises a plurality of mask blocks of different sizes, shapes, and/or brightness levels.

12. The projection apparatus according to claim 1, wherein the mask block is formed by splicing a plurality of sub-mask blocks.

13. The projection apparatus according to claim 1, wherein the mask block is a black block.

14. The projection apparatus according to claim 8, wherein when the processor determines that the biological part exists in the projection space, the projector is controlled by the processor to reduce a luminous flux of the projector.

15. The projection apparatus according to claim 14, wherein the step of calculating the position of the biological part in the projection space comprises: the image capturing device calculating a distance of the biological part in the projection space from the projector, and wherein the step of reducing the luminous flux comprises: reducing the luminous flux by an adjustment extent, wherein the adjustment extent is negatively correlated with the distance of the biological part from the projector.

16. The projection apparatus according to claim 15, wherein the larger the distance of the biological part from the projector is, the smaller the adjustment extent is, and wherein the smaller the distance of the biological part from the projector is, the larger the adjustment extent is.

17. An operation method for a projection apparatus, the projection apparatus comprising a projector and an image capturing device electrically connected to the projector, wherein the operation method comprises:
the projector providing a projection space;
the image capturing device providing an image capturing space, wherein the projection space is located in the image capturing space;
the image capturing device identifying a boundary of the projection space in the image capturing space;
the image capturing device detecting a biological part located in the projection space;
the image capturing device calculating a position of the biological part in the projection space; and
the projector projecting a mask block corresponding to the position of the biological part in the projection space.

18. The operation method according to claim 17, wherein the step of identifying the boundary of the projection space in the image capturing space comprises: performing an edge detecting operation to identify the boundary of the projection area in the image capturing area.

19. The operation method according to claim 18, wherein a projected area of the mask block on the projection target is not smaller than a projected area of the biological part on the projection target.

20. The operation method according to claim 17, wherein the projection apparatus further comprises a processor, the processor being electrically connected to the projector and the image capturing device, wherein the step of detecting the biological part located in the projection space comprises: the image capturing device capturing an image for the projection space; the processor calculating a temperature distribution in the projection space based on a brightness distribution of the image; and the processor determining whether the biological part exists in the projection space.

21. The operation method according to claim 20, wherein the step of determining whether the biological part exists in the projection space comprises: in the calculated temperature distribution in the projection space, when a temperature value is higher than a temperature threshold, determining that the biological part exists in the projection space.

22. The operation method according to claim 20, wherein when the processor determines that the biological part exists in the projection space, the projector is controlled by the processor to reduce a luminous flux the projector.

23. The operation method according to claim 17, wherein the step of calculating the position of the biological part in the projection space comprises: the image capturing device calculating a distance of the biological part in the projection space from the projector, and wherein the step of reducing the luminous flux of the projector comprises: reducing the luminous flux of the projector by an adjustment extent, wherein the adjustment extent is negatively correlated with the distance of the biological part from the projector.

24. The operation method according to claim 23, wherein the larger the distance of the biological part from the projector is, the smaller the adjustment extent is, and wherein the smaller the distance of the biological part from the projector is, the larger the adjustment extent is.
